(19) United States
(12) Patent Application Publication
(10) Pub. No.: US 2013/0311728 A1
(43) Pub. Date: Nov. 21, 2013

(54) COMMUNICATION APPARATUS, METHOD FOR CONTROLLING THE SAME, AND RECORDING MEDIUM

(71) Applicant: CANON KABUSHIKI KAISHA, Tokyo (JP)

(72) Inventor: Naoyuki Ohara, Machida-shi (JP)

(73) Assignee: CANON KABUSHIKI KAISHA, Tokyo (JP)

(21) Appl. No.: 13/892,593

(22) Filed: May 13, 2013

(30) Foreign Application Priority Data
May 15, 2012 (JP) 2012-111889

(51) Int. Cl. G06F 12/00

(52) U.S. Cl. CPC G06F 12/00
USPC 711/154

(57) ABSTRACT

A communication apparatus includes a storage unit configured to store content data, a transmission unit configured to transmit the content data stored in the storage unit to an information processing apparatus, an operation unit configured to receive a user instruction, and a receiving unit configured to, after the operation unit accepts an instruction for starting transmission processing for transmitting the content data stored in the storage unit to the information processing apparatus, receive content data stored in another communication apparatus from the other communication apparatus, wherein, when the receiving unit receives the content data stored in the other communication apparatus, the transmission unit considers the content data received by the receiving unit in addition to the content data stored in the storage unit as transmission target content data to the information processing apparatus.

### BACKGROUND OF THE INVENTION

1. Field of the Invention

The present invention relates to a communication apparatus capable of uploading content data to an information processing apparatus via wireless communication.

2. Description of the Related Art

In recent years, increasing number of imaging apparatuses such as still cameras and video cameras have been provided with a wireless communication function for wirelessly communicating with other apparatuses. Under such situations, captured still and moving images, audio data, and other content data are shared between users by using the wireless communication function. For example, Japanese Patent Application Laid-Open No. 2007-201555 discusses a system which achieves content data sharing via a server by uploading to the server, by using the wireless communication function, content data acquired by an imaging apparatus having the wireless communication function.

Japanese Patent Application Laid-Open No. 2007-201555 premises that all of imaging apparatuses are provided with a function for directly uploading an image. However, actually, there are still a number of imaging apparatuses not having the function for directly uploading an image. This causes a situation in which apparatuses used by a plurality of users include apparatuses having the function for directly uploading an image and apparatuses not having the relevant function. Under such a situation, an imaging apparatus having the function for directly uploading an image can upload content data directly and easily while an imaging apparatus not having the relevant function needs to once connect with a personal computer (PC), for example, and upload content data via the PC.

### SUMMARY OF THE INVENTION

According to an aspect of the present invention, a communication apparatus includes a storage unit configured to store content data, a transmission unit configured to transmit the content data stored in the storage unit to an information processing apparatus, an operation unit configured to receive a user instruction, and a receiving unit configured to, after the operation unit accepts an instruction for starting transmission processing for transmitting the content data stored in the storage unit to the information processing apparatus, receive content data stored in another communication apparatus from the other communication apparatus, wherein, when the receiving unit receives the content data stored in the other communication apparatus, the transmission unit considers the content data received by the receiving unit in addition to the content data stored in the storage unit as transmission target content data to the information processing apparatus.

According to the present invention, process for uploading content data can be reduced.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a system configuration according to a first exemplary embodiment.

FIG. 2 is a block diagram illustrating configurations of cameras and a server according to the first exemplary embodiment.

FIG. 3 is a flowchart illustrating operations performed by a camera 100 at the time of association processing according to the first exemplary embodiment.

FIG. 4 illustrates an example of a screen displayed on the camera 100 at the time of association processing according to the first exemplary embodiment.

FIG. 5 is a flowchart illustrating operations performed by a camera 200 at the time of association processing according to the first exemplary embodiment.

FIG. 6 is a flowchart illustrating operations performed by the camera 100 at the time of image-capturing processing according to the first exemplary embodiment.

FIG. 7 is a flowchart illustrating operations performed by the camera 100 at the time of upload processing according to the first exemplary embodiment.

FIGS. 8A, 8B, and 8C illustrate examples of screens displayed on the camera 100 at the time of upload processing according to the first exemplary embodiment.

FIG. 9 is a flowchart illustrating operations performed by the camera 100 at the time of upload processing according to a second exemplary embodiment.

FIGS. 10A and 10B illustrate an example of a screen displayed on the camera 100 at the time of upload processing according to the second exemplary embodiment.

FIGS. 11A and 11B illustrate an example of a screen displayed on the camera 100 at the time of upload processing according to other exemplary embodiment.

FIG. 12 illustrates an example of a screen displayed on the camera 100 at the time of upload processing according to another exemplary embodiment.

### DESCRIPTION OF THE EMBODIMENTS

Various exemplary embodiments, features, and aspects of the invention will be described in detail below with reference to the drawings.

The following exemplary embodiments are to be considered as illustrative examples for achieving the present invention, and may be corrected, modified, and combined as required depending on the configuration of an apparatus according to the present invention and other various conditions.

### <System Configuration>

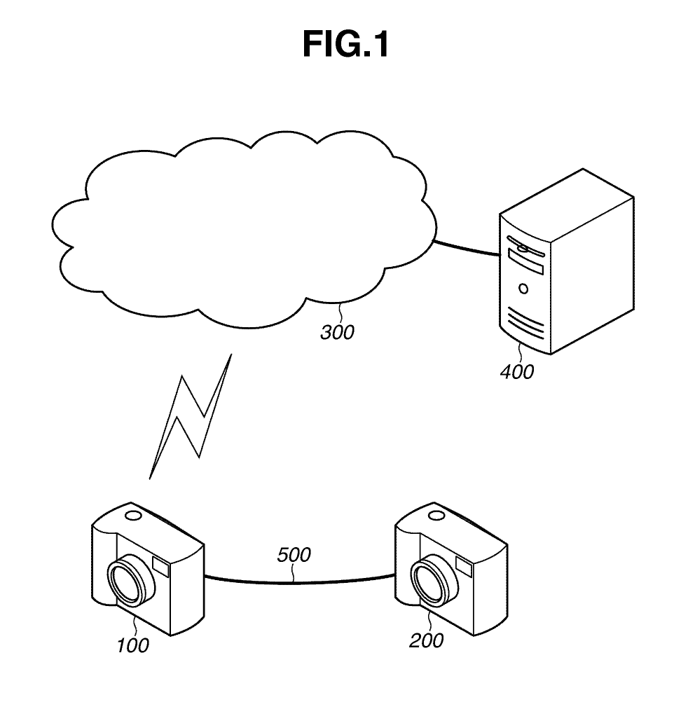

FIG. 1 illustrates a system configuration according to a first exemplary embodiment of the present invention. The system includes a camera 100, a camera 200, a network 300, a server 400, and a cable 500. The cameras 100 and 200 indicate imaging apparatuses which capture still and moving images and then record them in a recording medium. Imaging apparatuses are, for example, digital video cameras, digital still cameras, and communication apparatuses, for example, mobile phones having the camera function, PCs, and tablet devices. A server 400 indicates an information processing apparatus which receives data from other apparatuses, stores the data, and manages the data. The information processing apparatus may be a PC.

The cameras 100 and 200 are connected with each other via the cable 500. The cable 500 may be a universal serial bus (USB) cable or an Institute of Electrical and Electronics Engineers (IEEE) 1394 cable. Alternatively, the cameras 100 and 200 are also connected with each other via near-field wireless communication. The present exemplary embodiment will be described below based on a case where the cable 500 is a USB cable.

The camera 100 can be connected with the server 400 via a network 300. The network 300 may be a wireless local area network (LAN). In the present exemplary embodiment, the network 300 is the Internet network via one or a plurality of access points. The server 400 receives an image transmitted from the camera 100, and stores the image in a recording medium in the server 400. On the other hand, the camera 200 does not have a means for connecting with the network 300 via the wireless LAN and therefore cannot communicate with the server 400.

### <Internal Configuration of the Camera 100>

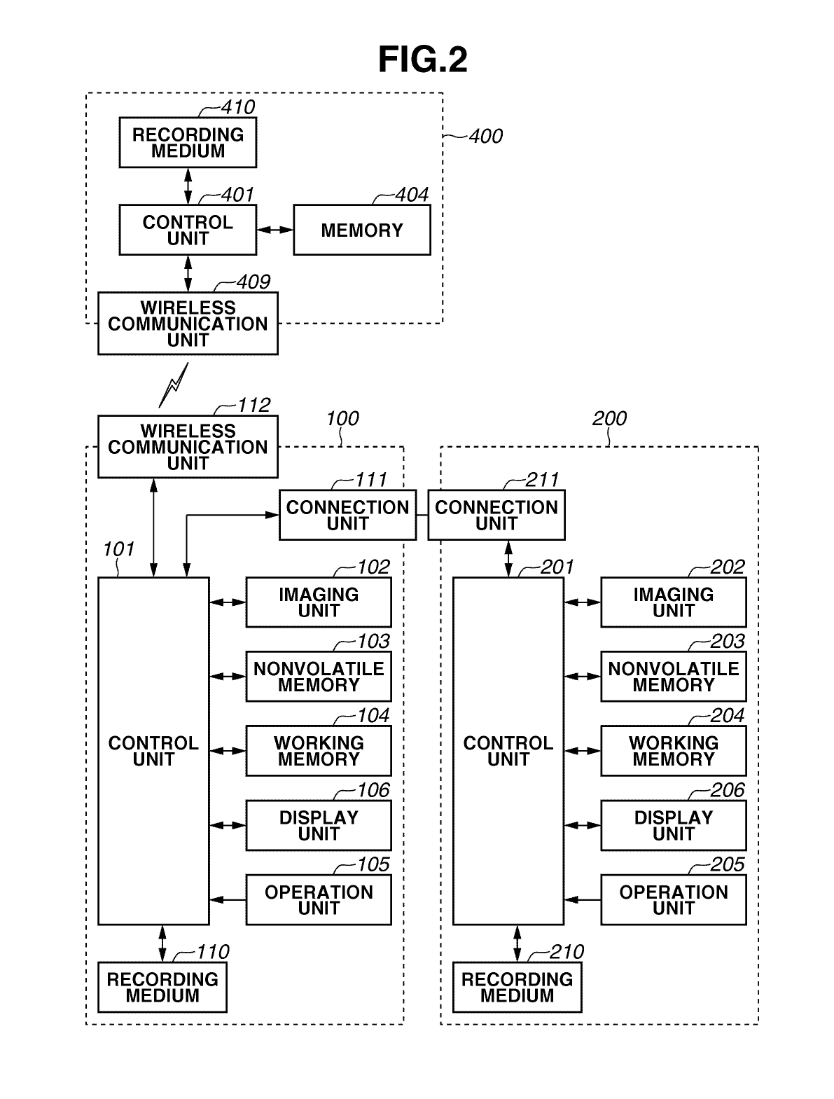

The configurations of the camera 100, the camera 200, and the server 400 will be described below with reference to FIG. 2.

The configuration of the camera 100 will be described first.

A control unit 101 controls each component of the camera 100 according to an input signal and a program (described below). The camera 100 according to the present exemplary embodiment is provided with operation tasks: an imaging task, a display task, a connection task, and a communication task. The imaging task generates content data such as still and moving images by using an imaging unit 102. The connection task communicates with an apparatus connected with the camera 100 via a connection unit 111. The communication task transmits an image to the server 400 via a wireless communication unit 112. The display task displays on a display unit 106 content data generated by the imaging task. Of these tasks, the imaging task, the display task, and the communication task are selected and executed through a menu operation by the user via an operation unit 105. The connection task is executed when the camera 100 detects connection with an external apparatus via the connection unit 111. The control unit 101 controls these tasks according to the program recorded in a nonvolatile memory 103 (described below). Instead of the control unit 101, a plurality of hardware components in charge of respective processing may control the entire imaging apparatus.

The imaging unit 102 performs imaging processing. The imaging processing converts object light formed by a lens included in the imaging unit 102 into an electrical signal, applies noise reduction processing to the electrical signal, and outputs resultant digital data as an image. The control unit 101 stores the captured image in a buffer memory, applies a predetermined operation to it, and records a resultant image in a recording medium 110.

The nonvolatile memory 103 is an electrically erasable and recordable nonvolatile memory for storing a program (described below) to be executed by the control unit 101.

A working memory 104 is used as a buffer memory for temporarily storing images captured by the imaging unit 102, an image display memory for the display unit 106, and a working area for the control unit 101.

The operation unit 105 is used to accept an instruction to the camera 100 from the user. The operation unit 105 includes operation members used by the user to give instructions to the camera 100, such as a power button for instructing the camera 100 to turn the power of the camera 100 ON and OFF, a release switch for instructing it to perform imaging processing, and a playback button for instructing it to play back captured images. The release switch has two different states: SW1 and SW2. SW1 turns ON when the release switch is in the half press state. In this state, the camera 100 accepts an instruction for performing an image-capturing preparation operation including automatic focus (AF) processing, automatic exposure (AE) processing, automatic white balance (AWB) processing, and electronic flash preliminary emission (FP) processing. SW2 turns ON when the release switch is in the full press state. In this state, the camera 100 accepts an instruction for performing imaging processing.

The display unit 106 displays a view finder image at the time of image-capturing, a captured image, and characters for interactive operations. The camera 100 does not necessarily include the display unit 106. However, the camera 100 can be connected with the display unit 106 and is provided with at least a display control function for controlling display of the display unit 106.

The recording medium 110 can record images output from the imaging unit 102 and images acquired via the connection unit 111 (described below). The recording medium 110 may be detachably attached to the camera 100 or included in the camera 100. Furthermore, the camera 100 has at least a means for accessing to the recording medium 110.

The connection unit 111 communicates with an external apparatus. The camera 100 can exchange data with the external apparatus via the connection unit 111. In the present exemplary embodiment, the connection unit 111 is a USB interface, which enables connecting the camera 100 with a connection unit 211 of the camera 200 via a USB cable. Through the connection task, the control unit 101 communicates with the camera 200 via the USB cable. The connection unit 111 may be an interface for performing other wire communications. Instead, near-field wireless communication may be used.

The wireless communication unit 112 wirelessly communicates with an external apparatus. The camera 100 can be connected to the Internet network via the wireless communication unit 112. In the present exemplary embodiment, the wireless communication unit 112 is a wireless LAN interface. Through the communication task, the camera 100 can be connected with the server 400 (described below) via the Internet network.

This completes description of the camera 100.

### <Internal Configuration of Camera 200>

The camera 200 will be described below.

The configurations of the cameras 100 and 200 have many common elements, descriptions will be made centering on elements specific to the camera 200, and redundant description thereof will be omitted.

The camera 200 includes a control unit 201, an imaging unit 202, a nonvolatile memory 203, a working memory 204, an operation unit 205, a display unit 206, and a recording medium 210. These units are similar to those of the camera 100, and redundant description thereof will be omitted.

The connection unit 211 communicates with an external apparatus. The camera 200 can exchange data with the external apparatus via the connection unit 211. In the present exemplary embodiment, the connection unit 211 is a USB interface, which enables connecting the camera 200 with the connection unit 111 of the camera 100 via a USB cable. The control unit 201 communicates with the camera 100 via the USB cable.

Since the camera 200 does not include a unit equivalent to the wireless communication unit 112 of the camera 100, the camera 200 cannot connect with the server 400. Therefore, the camera 200 is not provided with the communication task for communicating with the server 400, either.

This completes description of the camera 200.

### <Internal Configuration of the Server 400>

The server 400 will be described below.

The control unit 401 controls each component of the server 400 according to an input signal and a program (described below). Instead of the control unit 401, a plurality of hardware components in charge of respective processing may control the entire imaging apparatus.

A memory 404 is used as a buffer memory for temporarily storing data and a working area for the control unit 401.

A recording medium 410 stores various types of control programs executed by the control unit 401, an operating system (OS), and content data such as image and audio files. The recording medium 410 may be detachably attached to the server 400 or included in the server 400. Furthermore the server 400 has at least a means for accessing the recording medium 410.

This completes description of the server 400.

### <Overall Processing Flow>

Overall processing flow will be described below. In the present exemplary embodiment, images are generated by each imaging apparatus as content data. Prior to image-capturing by the cameras 100 and 200, the user associates the cameras 100 and 200 with each other by connecting the cameras 100 and 200. Then, the user cancels connection of the cameras 100 and 200, and captures images by using each of the cameras 100 and 200. Then, when the communication task of the camera 100 is executed through a menu operation by the user, the camera 100 prompts the user to connect the associated camera 200 to the camera 100. Following this prompt, the user connects the camera 200 to the camera 100. Then, the camera 100 automatically transmits to the server 400 images of the camera 200 together with images of the camera 100. Specifically, images captured by the camera 100 and images captured by the camera 200 are collectively uploaded to the server 400. Using the camera 100 according to the present exemplary embodiment in this way enables collectively uploading images of the camera 100 and images of the camera 200 not having the wireless communication function. Therefore, images captured by the cameras 100 and 200 can be easily shared by each other.

The association processing, imaging processing, and processing for uploading images to the server are described below among above-described processing.

### <Association>

Through the connection task executed upon detection of connection with the camera 200 via the connection unit 111, the camera 100 according to the present exemplary embodiment can perform association between the cameras 100 and 200.

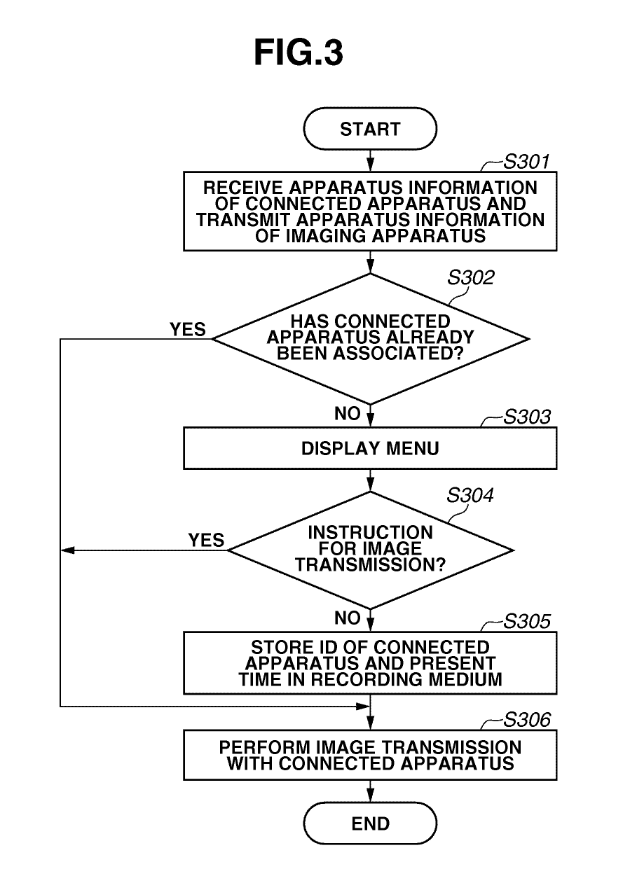

FIG. 3 is a flowchart illustrating operations performed by the camera 100 at the time of association processing through the connection task. Processing illustrated in this flowchart is implemented when the control unit 101 of the camera 100 executes a program recorded in the nonvolatile memory 103 and controls each unit of the camera 100 according to the program. This also applies to subsequent flowcharts executed by the camera 100. Processing illustrated in this flowchart is started in response to the activation of the connection task.

In step S301, the control unit 101 and an apparatus connected thereto mutually acquire apparatus information from each other. More specifically, the control unit 101 transmits an apparatus information request to the connected apparatus and then receives the relevant apparatus information from the connected apparatus. Similarly, in response to the apparatus information request from the connected apparatus, the control unit 101 transmits to the connected apparatus the relevant apparatus information stored in the nonvolatile memory 103. The apparatus information according to the present exemplary embodiment includes information indicating the model name of the camera 100 and an identifier (ID) indicating a value specific to the camera 100.

In step S302, the control unit 101 determines whether the connected apparatus is an apparatus that has already been associated with the camera 100. The camera 100 according to the present exemplary embodiment pre-stores the ID of the associated apparatus in the nonvolatile memory 103. In step S302, the camera 100 compares an ID included in the apparatus information received in step S301 with the pre-stored ID to determine whether the connected apparatus is an apparatus that has already been associated with the camera 100. As a result of the comparison, when the ID included in the apparatus information received in step S301 coincides with the ID stored in the nonvolatile memory 103, the control unit 101 determines that the connected apparatus is an apparatus that has already been associated with the camera 100. As a result of the comparison, when the ID included in the apparatus information received in step S301 does not coincide with the ID stored in the nonvolatile memory 103, the control unit 101 determines that the connected apparatus is not an apparatus that has already been associated with the camera 100. When the control unit 101 determines that the connected apparatus is an apparatus that has already been associated with the camera 100 (YES in step S302), the processing proceeds to step S306. The processing in step S306 will be described below. On the other hand, when the control unit 101 determines that the connected apparatus is not an apparatus that has already been associated with the camera 100 (NO in step S302), the processing proceeds to step S303.

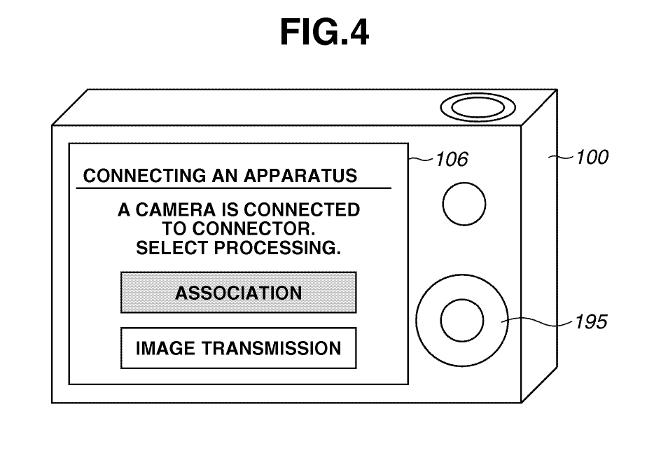

In step S303, the control unit 101 displays a menu for selecting whether the connected apparatus is to be associated with the camera 100, and whether images are to be exchanged between the connected apparatus and the camera 100. FIG. 4 illustrates an example of a displayed menu. By selecting an “ASSOCIATION” button via the operation unit 105, the user can input an instruction for associating the connected apparatus with the camera 100. By selecting an “IMAGE TRANSMISSION” button via the operation unit 105, the user can input an instruction for exchanging images between the connected apparatus and the camera 100.

In step S304, the control unit 101 determines the accepted instruction. When the control unit 101 determines that the accepted instruction is an instruction for exchanging images between the connected apparatus and the camera 100 (YES in step S304), the processing proceeds to step S306. On the other hand, when the control unit 101 determines that the accepted instruction is an instruction for associating the connected apparatus with the camera 100 (NO in step S304), the processing proceeds to step S305.

In step S305, the control unit 101 associates the connected apparatus with the camera 100. More specifically, the control unit 101 stores the ID acquired in step S301 in the nonvolatile memory 103 as the ID of the associated apparatus. In this case, the control unit 101 also stores the time when the ID is stored (i.e., the time when association is performed). The stored time is to be used in upload processing (described below). Then, the processing proceeds to step S306.

In step S306, the control unit 101 performs image transmission with the connected apparatus. For example, the user can select via the operation unit 105 images recorded on the recording medium 110 and then transmit them to the connected apparatus. The user can also receive images from the connected apparatus.

This completes description of the operation performed by the camera 100 at the time of association processing. The corresponding operations performed by the camera 200 is described.

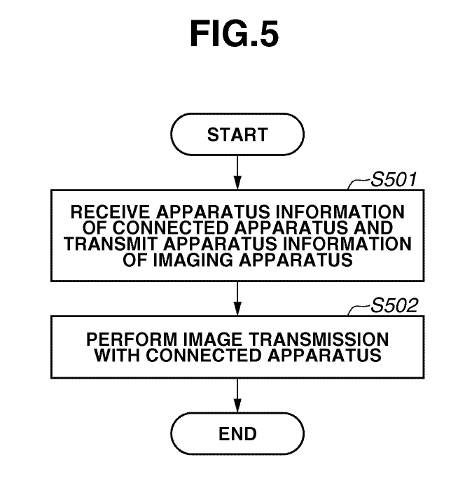

FIG. 5 is a flowchart illustrating operations performed by the camera 200 at the time of association processing. Processing illustrated in this flowchart is implemented when the control unit 201 of the camera 200 executes a program recorded in the nonvolatile memory 203 and controls each unit of the camera 200 according to the program. Processing illustrated in this flowchart is started in response to the activation of the connection task.

In step S501, the control unit 201 performs similar processing to that in step S301 illustrated in FIG. 3.

In step S502, the control unit 201 performs image transmission with the connected apparatus. For example, the user can select an image recorded on the recording medium 210 and then transmit it to the connected apparatus via the operation unit 205. The user can also receive an image from the connected apparatus. The processing in step S502 corresponds to the image transmission processing by the camera 100 (step S306 illustrated in FIG. 3). This completes description of the operation performed by the camera 100 at the time of association processing.

### <Imaging>

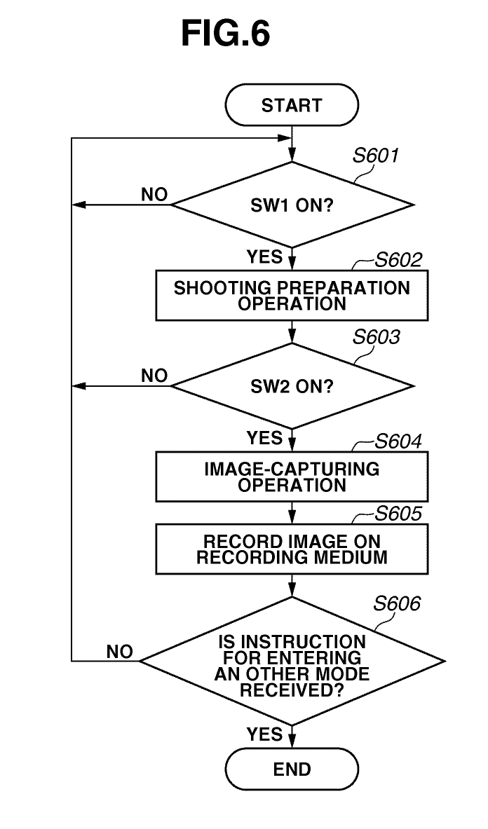

The processing performed by the imaging task of the camera 100 according to the present exemplary embodiment is described with reference to FIG. 6. FIG. 6 is a flowchart illustrating operations performed by the camera 100 in the imaging task. The processing illustrated in this flowchart is started when the power of the camera 100 is turned ON. In this state, the display unit 106 displays a through image input from the imaging unit 102. The user, while monitoring the image displayed on the display unit 106, can capture an image.

In step S601, the control unit 101 determines whether SW1 is turned ON. When the control unit 101 determines that SW1 is not turned ON (NO in step S601), the control unit 101 repeats the processing in step S601. On the other hand, when the control unit 101 determines that SW1 is turned ON (YES in step S601), the processing proceeds to step S602.

In step S602, the control unit 101 instructs the imaging unit 102 to perform the image-capturing preparation operation.

In step S603, the control unit 101 determines whether SW2 is turned ON. When the control unit 101 determines that SW2 is not turned ON (NO in step S603), the processing returns to step S601. On the other hand, when the control unit determines that SW2 is turned ON (YES in step S603), the processing proceeds to step S604.

In step S604, the control unit 101 performs an image-capturing operation via the imaging unit 102 to acquire an image.

In step S605, the control unit 101 records the image acquired in step S604 on the recording medium 110.

In step S606, the control unit 101 determines whether an instruction for entering another mode is accepted. For example, when the playback button included in the operation unit 105 is detected to be pressed, the control unit 101 determines that the instruction for entering the playback mode is accepted. When the control unit 101 determines that the instruction for entering another mode is not accepted (NO in step S606), the processing returns to step S601. On the other hand, when the control unit 101 determines that the instruction for entering another mode is accepted (YES in step S606), the processing exits this flowchart.

### <Uploading to the Server>

The upload operation for uploading data to the server 400 is described.

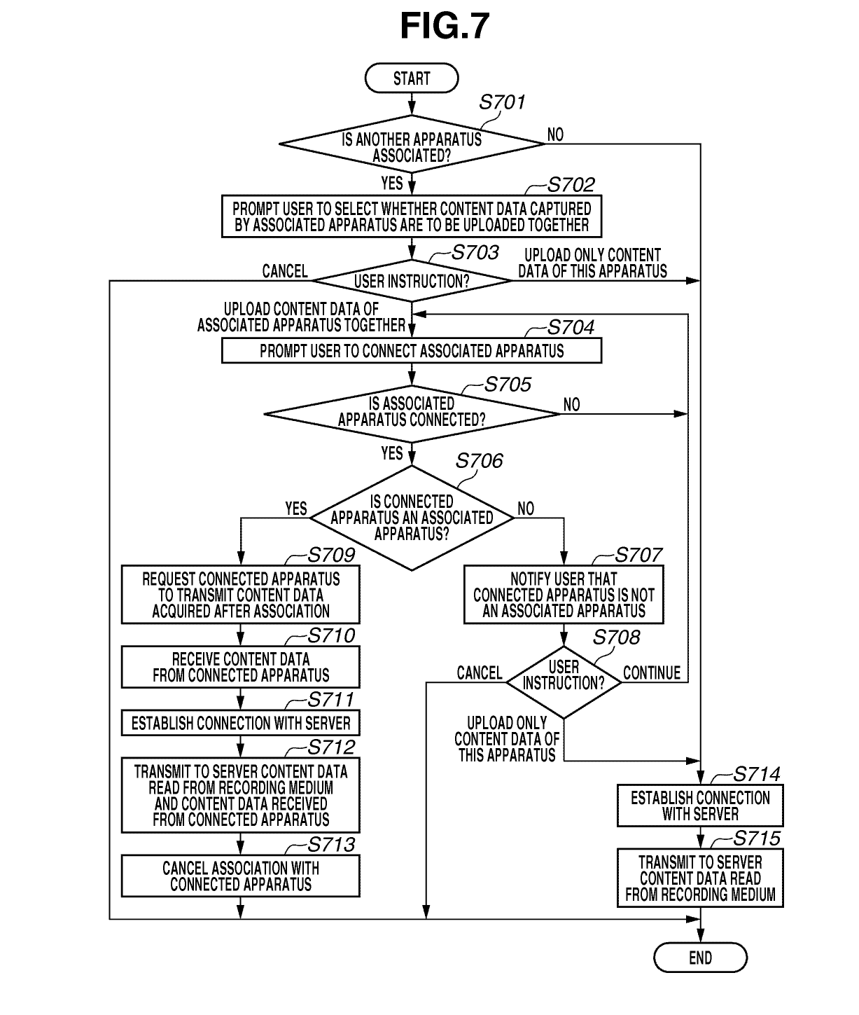

FIG. 7 is a flowchart illustrating operations performed by the camera 100 at the time of data uploading to the server 400. The processing illustrated in this flowchart is started when the communication task is executed through a menu operation by the user.

In step S701, the control unit 101 determines whether another apparatus is associated with the camera 100. More specifically, the control unit 101 determines whether the ID indicating the associated apparatus is stored in the nonvolatile memory 103. When the ID indicating the associated apparatus is not stored in the nonvolatile memory 103 (NO in step S701), the control unit 101 determines that the other apparatus has not yet been associated with the camera 100. On the other hand, when the ID indicating the associated apparatus is stored in the nonvolatile memory 103 (YES in step S701), the control unit 101 determines that the other apparatus has already been associated with the camera 100.

A case where the control unit 101 determines that the other apparatus has not yet been associated with the camera 100 in step S701, is described. In this case (NO in step S701), the processing proceeds to step S714. In step S714, the control unit 101 establishes connection with the server 400.

In step S715, the control unit 101 reads an image from the recording medium 110, and transmits a copy of the read image to the server 400 via the wireless communication unit 112, thus uploading the image recorded on the recording medium 110. When an image is recorded on the recording medium 110, a flag indicating whether the image has already been uploaded to the server 400 is stored together with the image. In step S715, referring to the flag, the control unit 101 uploads to the server 400 only images that have not yet been uploaded to the server 400. When all of images to be uploaded have been transmitted, the processing exits this flowchart. When all of images recorded on the recording medium 110 have already been uploaded to the server 400, the processing exits this flowchart without executing the processing in step S715.

A case where the control unit 101 determines in step S701 that the other apparatus has already been associated with the camera 100, is described. In this case (YES in step S701), the processing proceeds to step S702.

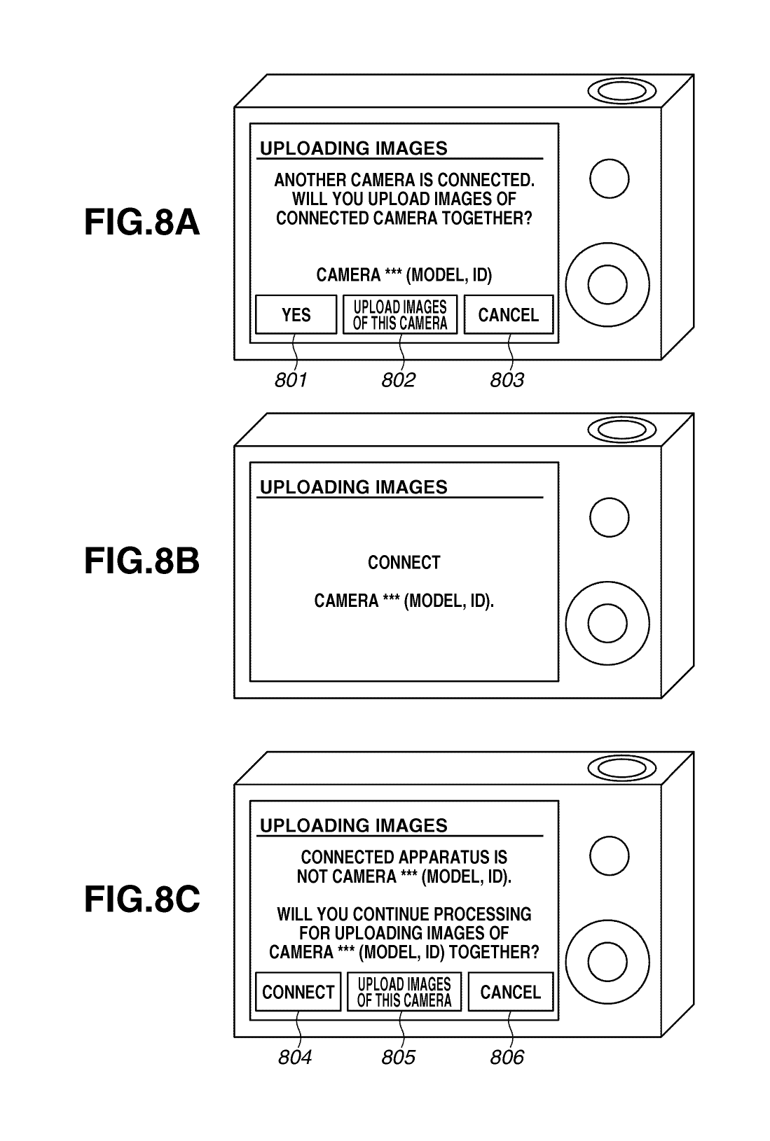

In step S702, the control unit 101 displays information about the associated apparatus on the display unit 106, and notifies the user of the fact that there exists an apparatus associated with the camera 100. Further, the camera 100 prompts the user to select whether images captured by the associated apparatus are to be uploaded together with images captured by the camera 100. At the same time, the control unit 101 receives an instruction corresponding to a user operation. For example, the control unit 101 displays a screen illustrated in FIG. 8A. The screen illustrated in FIG. 8A displays the ID of the camera 200 associated with the camera 100 and buttons 801 to 803. By selecting the “YES” button 801 via the operation unit 105, the user can input an instruction for collectively uploading images captured by the cameras 100 and 200. By selecting the “UPLOAD IMAGES OF THIS CAMERA” button 802 via the operation unit 105, the user can input an instruction for uploading only images captured by the camera 100 without uploading images captured by the camera 200. By selecting the “CANCEL” button 803 via the operation unit 105, the user can input an instruction for canceling the upload processing.

In step S703, the control unit 101 determines the instruction accepted via the screen displayed in step S702. When the control unit 101 determines that the instruction for canceling the upload processing is accepted (CANCEL in step S703), the processing exits this flowchart. On the other hand, when the control unit 101 determines that the instruction for uploading only images captured by the camera 100 without uploading images captured by the camera 200 is accepted (UPLOAD ONLY CONTENT DATA OF THIS APPARATUS in step S703), the processing proceeds to steps S714 and S715. Then, the control unit 101 uploads only images captured by the camera 100 to the server 400. On the other hand, when the control unit 101 determines that the instruction for collectively uploading images captured by the cameras 100 and 200 (UPLOAD CONTENT DATA OF ASSOCIATED APPARATUS TOGETHER in step S703), the processing proceeds to step S704.

In step S704, the control unit 101 displays on the display unit 106 a message for prompting the user to connect the associated apparatus via the connection unit 111. For example, a screen as illustrated in FIG. 8B is displayed. After confirming this message, the user can connect the camera 200 to the camera 100.

In step S705, the control unit 101 determines whether the associated apparatus is connected to the camera 100 via the connection unit 111. When the control unit 101 determines that the associated apparatus is not connected to the camera 100 (NO in step S705), the processing returns to step S704 to wait until it is connected. In step S705, the control unit 101 may further determine whether a predetermined time period has passed since the instruction for collectively uploading images captured by the cameras 100 and 200 is accepted in step S702 and, if the associated apparatus is not connected even after the predetermined time period has elapsed, the processing may return to step S702. On the other hand, when the control unit 101 determines that the apparatus is connected to the camera 100 (YES in step S705), the processing proceeds to step S706.

In step S706, the control unit 101 determines whether the apparatus connected to the camera 100 via the connection unit 111 is an associated apparatus. More specifically, similar to step S301 illustrated in FIG. 3, the control unit 101 and the connected apparatus mutually receive apparatus information from each other. At the same time, the control unit 101 reads the ID indicating the apparatus associated in advance stored in the nonvolatile memory 103. Then, the control unit 101 compares the ID included in the received apparatus information with the ID read from the nonvolatile memory 103 to determine whether the two IDs coincide with each other, thus determining whether the apparatus connected to the camera 100 via the connection unit 111 is an associated apparatus.

A case where the control unit 101 determines that the connected apparatus is not an associated apparatus in step S706, is described. In this case (NO in step S706), the processing proceeds to step S707.

In step S707, the control unit 101 notifies the user of the fact that the connected apparatus is not an associated apparatus and, at the same time, prompts the user to select whether the upload processing is to be continued. More specifically, the control unit 101 displays on the display unit 106 a screen as illustrated in FIG. 8C. The screen illustrated in FIG. 8C displays a message indicating that the connected apparatus is not an associated apparatus, and buttons 804 to 806. By selecting the “CONNECT” button 804 via the operation unit 105, the user can input an instruction for continuing the processing for collectively uploading images captured by the cameras 100 and 200. By selecting the “UPLOAD IMAGES OF THIS CAMERA” button 805 via the operation unit 105, the user can input an instruction for canceling the processing for collectively uploading images captured by the cameras 100 and 200 and uploading only images captured by the camera 100. By selecting the “CANCEL” button 806 via the operation unit 105, the user can input an instruction for canceling the upload processing.

In step S708, the control unit 101 determines the instruction accepted in step S707. When the control unit 101 determines that the instruction for canceling the upload processing is accepted (CANCEL in step S708), the processing exits this flowchart. When the control unit 101 determines that the instruction for canceling the processing for collectively uploading images captured by the cameras 100 and 200 and uploading only images captured by the camera 100 is accepted (UPLOAD CONTENT DATA OF THIS APPARATUS in step S708), the processing proceeds to steps S714 and S715. Then, the control unit 101 uploads only images captured by the camera 100 to the server 400. When the control unit 101 determines that the instruction for continuing the processing for collectively uploading images captured by the cameras 100 and 200 is accepted (CONTINUE in step S708), the processing returns to step S704.

This completes description of the processing performed when the control unit 101 determines that the connected apparatus is not an associated apparatus.

A case where the control unit 101 determines that the connected apparatus is an associated apparatus in step S706, is described. In this case (YES in step S706), the processing proceeds to step S709.

In step S709, the control unit 101 requests the connected apparatus to transmit images to the control unit 101. More specifically, before transmitting the request, the control unit 101 reads the time when the apparatus was associated from the nonvolatile memory 103. This time is the time stored together with the ID in step S305 illustrated in FIG. 3. Then, the control unit 101 transmits to the camera 200 a request for transmitting images captured after the read time to the camera 100.

In step S710, the control unit 101 receives from the camera 200 a response in response to the request. This response includes the requested images out of images captured by the camera 200.

In step S711, the control unit 101 establishes connection with the server 400.

In step S712, similar to the processing in step S715, the control unit 101 reads from the recording medium 110 images that have not yet been uploaded to the server 400. Then, the control unit 101 collectively transmits to the server 400 copies of the read images and images captured by the camera 200 received in step S710.

In step S713, the control unit 101 disassociates the connected apparatus. More specifically, the control unit 101 deletes the relevant apparatus information recorded in the nonvolatile memory 103. Then, the camera 100 cancels the association with the camera 200. This completes description of the upload processing.

The association processing, imaging processing, and processing for uploading images to the server 400 have specifically been described above.

As described above, in the present exemplary embodiment, associating the camera 200 with the camera 100 having a wireless communication function enables collectively uploading images of the cameras 100 and 200 to the server 400. This eliminates the need of using a PC to upload images of the camera 200 not having the wireless communication function, reducing the process of uploading images acquired by the cameras 100 and 200 to the server 400.

The first exemplary embodiment has specifically been described above based on a case where the camera 200 is associated with the camera 100. However, the number of apparatuses to be associated with the camera 100 is not limited to one. The second exemplary embodiment will be described below based on a case where a plurality of cameras is associated with the camera 100 and images of three or more cameras are uploaded to the server 400. The present and first exemplary embodiments have common elements, and redundant description thereof will be omitted. Descriptions will be made centering on elements specific to the present exemplary embodiment.

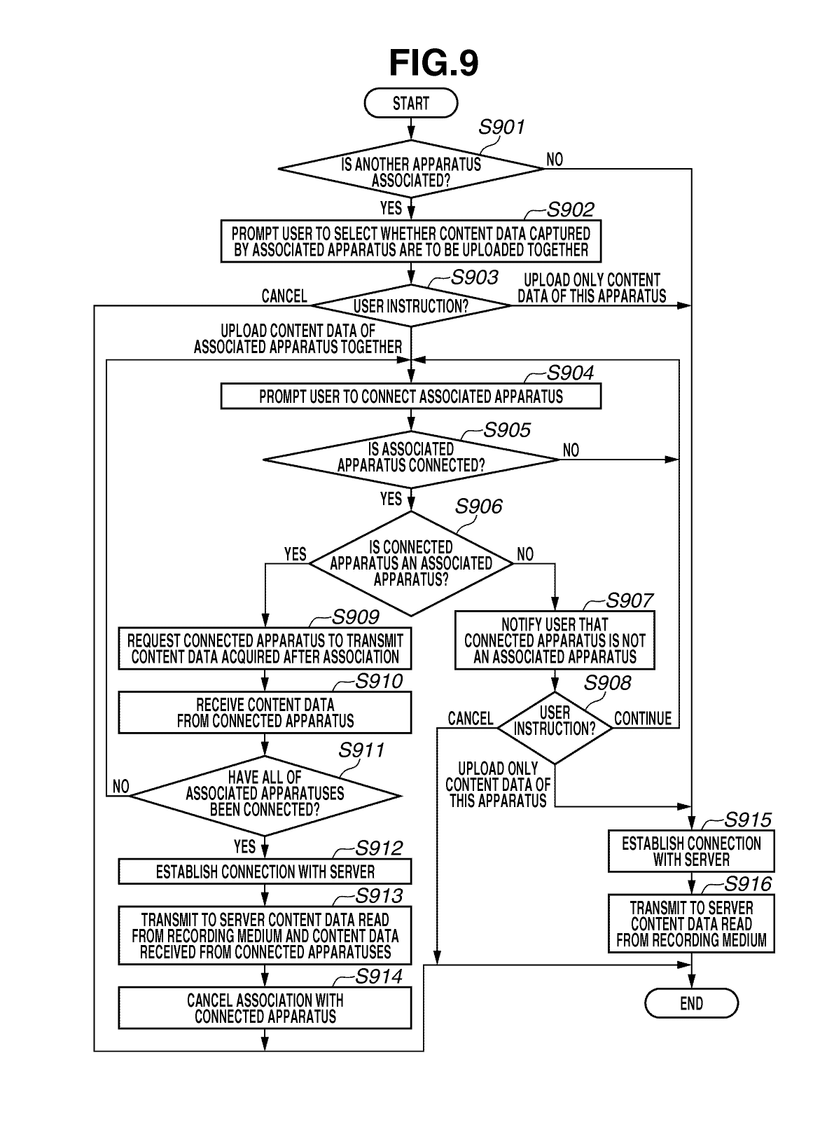

FIG. 9 is a flowchart illustrating operations performed by the camera 100 at the time of processing for uploading images to the server 400. The processing illustrated in this flowchart is started when the communication task is executed through a menu operation by the user. Before starting this processing, the camera 100 repeats several times similar processing to that illustrated in FIG. 3 to associate a desired number of cameras with the camera 100. More specifically, each time the processing illustrated in FIG. 3 is completed, the user disconnects the cable between the cameras and connects to the camera 100 the next camera to be associated with the camera 100. Then, the processing illustrated in FIG. 3 is repetitively executed.

In steps S901 to S903 illustrated in FIG. 9, the control unit 101 performs similar processing to that in steps S701 to S703 illustrated in FIG. 7.

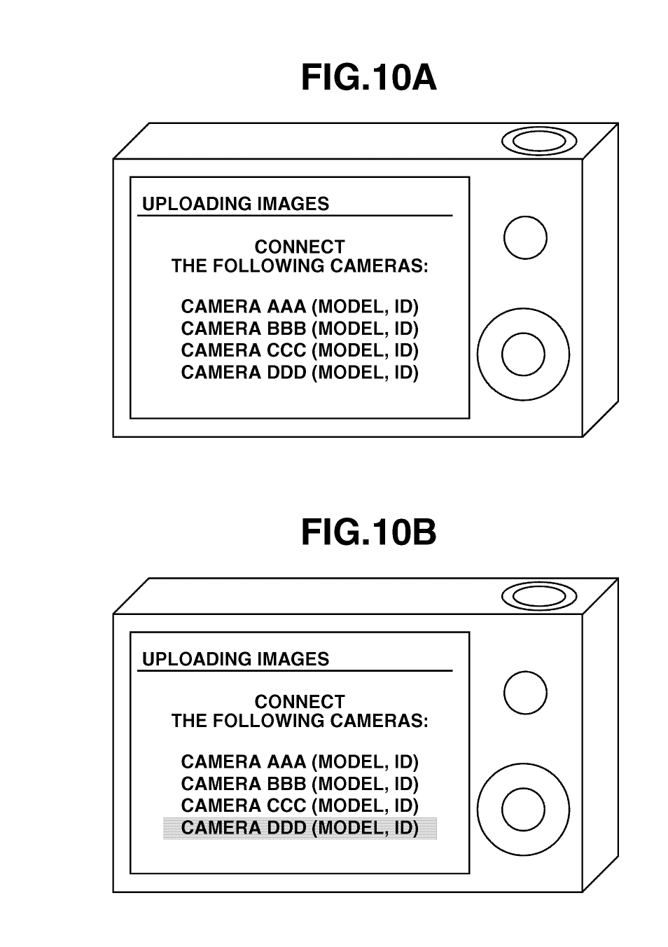

In step S904, the control unit 101 displays on the display unit 106 a message for prompting the user to connect an associated apparatus to the camera 100 via the connection unit 111. For example, a screen as illustrated in FIG. 10A is displayed. In the present exemplary embodiment, since a plurality of apparatuses is associated with the camera 100, the IDs of the plurality of apparatuses are displayed in step S904. In the present exemplary embodiment, four cameras are associated with the camera 100 and information about the four cameras is displayed in the screen illustrated in FIG. 10A.

In steps S905 to S910, the control unit 101 performs similar processing to that in steps S705 to S710 illustrated in FIG. 7. In the present exemplary embodiment, the control unit 101 repeats the processing in step S910 to receive images from the plurality of apparatuses, and temporarily stores in the working memory 104 images received in respective loops.

In step S911, the control unit 101 determines whether all of associated apparatuses have been connected.

A case where the control unit 101 determines that there is an apparatus that has not yet been connected, is described. In this case (NO in step S911), the processing returns to step S904. In step S904, the control unit 101 grays out the ID of an apparatus that has already been connected, as illustrated in FIG. 10B. Confirming this display, the user can determine the apparatus that has not yet been connected. Then, the user removes the cable from the currently connected apparatus to disconnect the apparatus from the camera 100, and connect another associated apparatus to the camera 100. Repeating this process enables sequentially connecting a plurality of associated apparatuses and acquiring images from each apparatus. This processing can be achieved by performing the following operations. Specifically, when the control unit 101 determines that the connected apparatus is an apparatus that has already been associated (YES in step S906), the control unit 101 stores in the working memory 104 the ID of the connected apparatus as the ID indicating an apparatus that has already been connected during processing of this flowchart. Then, the processing returns to step S905 via step S911. When the control unit 101 determines that an apparatus is connected again (YES in step S905), then in step S906, the control unit 101 compares the ID acquired from the newly connected apparatus with the ID indicating an apparatus that has already been connected during processing of this flowchart to determine whether the connected apparatus is an associated apparatus.

When the control unit 101 determines that all of the associated apparatuses have been connected to the camera 100 (YES in step S911), the processing proceeds to step S912.

In step S912, the control unit 101 establishes connection with the server 400.

In step S913, similar to step S715 illustrated in FIG. 7, the control unit 101 reads from the recording medium 110 images that have not yet been uploaded to the server 400. Then, the control unit 101 collectively transmits to the server 400 copies of images read from the recording medium 110 and images repetitively received from connected apparatuses and stored in step S910. Thus, images acquired by the plurality of apparatuses and images captured by the camera 100 can be collectively uploaded to the server 400.

In steps S914 to S916, the control unit 101 performs similar processing to that in steps S711 to S715 illustrated in FIG. 7.

The operations performed by the camera 100 at the time of processing for uploading images to the server 400 according to the present exemplary embodiment has specifically been described. The camera 100 according to the present exemplary embodiment enables collectively transmitting to the server 400 content data acquired by the plurality of apparatuses, eliminating the need of transmitting content data for each individual apparatus. Thus, the process of sharing content data can be reduced.

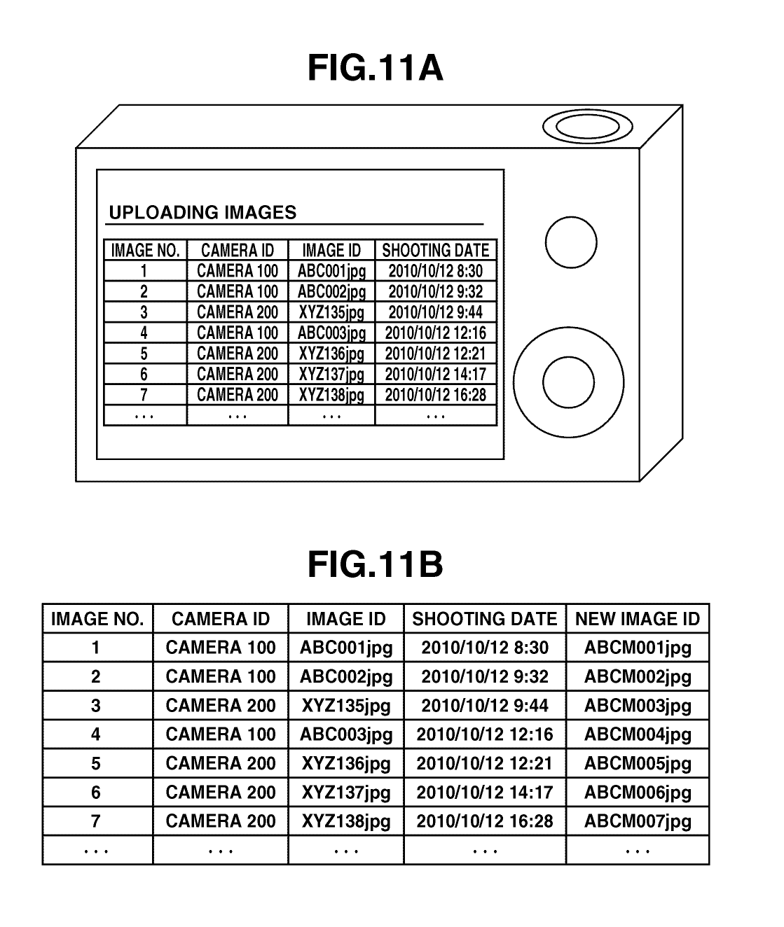

In addition to the above-described exemplary embodiments, when uploading images to the server 400, the control unit 101 may display a list of images to be uploaded and prompt the user to make confirmation. In this case, for example, a step for displaying a screen as illustrated in FIG. 11A is provided between steps S710 and S711 illustrated in FIG. 7. Further, on the screen illustrated in FIG. 11A, the user may select via the operation unit 105 images not to be uploaded.

Further, in addition to the above-described exemplary embodiments, before uploading images to the server 400, the control unit 101 may time-sequentially sort images to be uploaded and then change the name (image ID) of each image to indicate the order in the result of sorting. When changing the name, the control unit 101 may rename each image received from the camera 200 according to the naming format of images captured by the camera 100. For example, when images described in a list illustrated in FIG. 11A are time-sequentially sorted, a list illustrated in FIG. 11B results. Referring to the list illustrated in FIG. 11B, the name of each image includes a sequential number indicating the order in the result of sorting. Thus, the control unit 101 may provide an additional column of changed name (new image ID) in the list to present the user with how the images to be uploaded will be renamed.

In addition to the above-described exemplary embodiments, the control unit 101 may append common metadata to each of the images to be uploaded to the server 400. More specifically, when the name of place, shooting location, or event name is appended to an image, for example, the control unit 101 may append similar name of place, shooting location, or event name to other images whose shooting time is within a predetermined time range since the shooting time of the image.

Although, in the above-described exemplary embodiments, the control unit 101 uploads images that have not yet been uploaded at the time of processing for uploading images captured by the camera 100, the processing is not limited thereto. For example, the control unit 101 may allow the user to select images to be uploaded. In this case, the control unit 101 displays an icon for each image that has already been uploaded to enable distinguishing the image from other ones.

Although, in the second exemplary embodiment, the ID of an apparatus that has already been connected is grayed out during processing, the processing is not limited thereto. In addition to the above-described processing, when an apparatus that has already been connected is connected again, the control unit 101 may notify the user of the fact that images have been acquired from the connected apparatus, and prompt the user to reconnect other apparatus, thus preventing duplicated image acquisition from the relevant apparatus.

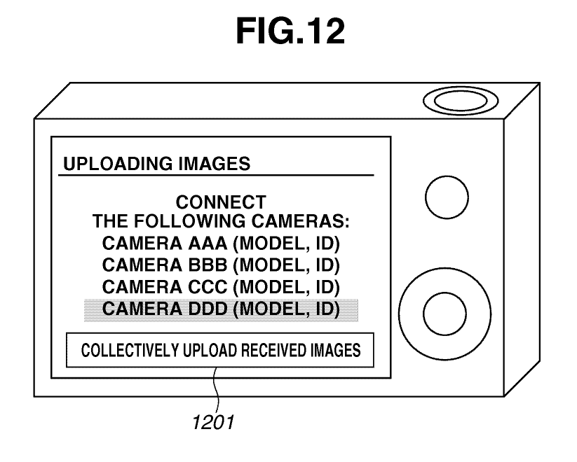

Although, in the second exemplary embodiment, all of associated apparatuses are connected to the camera 100 in advance and then images thereof are uploaded to the server 400, the processing is not limited thereto. Not all of the associated apparatuses may be connectable with the camera 100 at the timing of upload processing. The states where an associated apparatus cannot be connected with the camera 100 include, for example, a case where the power of the associated apparatus fails and a state where an associated apparatus is far from the camera 100. Therefore, when not all of the associated apparatuses are connected, the control unit 101 may upload only images of the connected apparatuses. In this case, for example, the control unit 101 displays a screen as illustrated in FIG. 12 in step S904 illustrated in FIG. 9. By selecting a “COLLECTIVELY UPLOAD RECEIVED IMAGES” button 1201 displayed on the screen, the user can input an instruction for uploading to the server 400 images received from the connected apparatuses during execution of the processing illustrated in the flowchart in FIG. 9 together with images captured by the camera 100.

Although, in the second above-described exemplary embodiment, images are transmitted to the server 400 and then the other apparatuses are disassociated, the processing is not limited thereto. For example, the control unit 101 may disassociate another apparatus when images have been received from the other apparatus. For example, the control unit 101 performs processing in step S914 between steps S910 and S911. As a result, the ID of the connected apparatus is deleted from the nonvolatile memory 103. Then, when the processing returns to step S904 via step S911, the control unit 101 prompts the user to connect the other apparatus to the camera 100. As described above, in step S904, the control unit 101 reads the IDs stored in the nonvolatile memory 103 and displays information about the apparatuses indicated by the IDs to prompt the user to connect the other apparatus to the camera 100. More specifically, the control unit 101 does not display information about apparatuses whose IDs have already been deleted from the nonvolatile memory 103. As a result, a notification for prompting the user to connect other apparatus does not display apparatuses from which images have already been received. When processing is performed in this way, as described above, it is not necessary to store the ID of the connected apparatus in the working memory 104 during processing of this flowchart.

Although, in the above-described exemplary embodiments, a notification to the user is displayed on the display unit 106, the notification may be output from a speaker provided on the camera 100. For example, a warning beep may be output. Alternatively, a displayed message may be read out in combination with the notification display. Further, in addition to the above-described exemplary embodiments, in a case where the camera 100 is connected to the camera 200 after receiving an instruction to perform transmission processing, the control unit 101 may notify the camera 200 that the image captured by the camera 200 can be uploaded. In this case, the control unit 101 transmits the notification to the camera 200 between steps S706 and S709, for example. In this way, a message indicating that the captured images can be uploaded is displayed on the display unit of the camera 200 to enable the user to recognize that uploading is possible. Further, in order to enable the user to recognize which image is uploaded, a list of the upload target images among the captured images may be displayed. Further, an operation unit for selecting upload target images from the list or excluding images from the list may be provided.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-111889 filed May 15, 2012, which is hereby incorporated by reference herein in its entirety.

What is claimed is:

1. A communication apparatus comprising:
a storage unit configured to store first content data;
a transmission unit configured to transmit the first content data to an information processing apparatus;
an operation unit configured to receive a user instruction; and
a receiving unit configured to, after the operation unit accepts an instruction for starting transmission processing for transmitting the first content data to the information processing apparatus, receive second content data stored in another communication apparatus,
wherein, when the receiving unit receives the second content data, the transmission unit considers the second content data in addition to the first content data as transmission target content data to the information processing apparatus.

2. The communication apparatus according to claim 1, wherein the transmission processing includes processing for transmitting the transmission target content data to the information processing apparatus.

3. The communication apparatus according to claim 2, wherein, when the receiving unit receives the second content data before the operation unit accepts an instruction for executing processing for transmitting the transmission target content data to the information processing apparatus, the transmission unit also considers the second content data as transmission target content data to the information processing apparatus.

4. The communication apparatus according to claim 1, further comprising:
a notification unit configured to, when the operation unit receives an instruction for starting the transmission processing, output a notification for notifying the user that content data can be received from the other communication apparatus.

5. The communication apparatus according to claim 4, wherein the notification unit displays the notification on a display unit.

6. The communication apparatus according to claim 4, wherein the transmission unit does not consider as transmission target content data to the information processing apparatus the received content data before the notification unit outputs the notification.

7. The communication apparatus according to claim 1, further comprising:
an association unit configured to associate the other communication apparatus with the communication apparatus,
wherein the transmission unit does not consider as transmission target content data the content data stored in the other communication apparatus not associated by the association unit.

8. The communication apparatus according to claim 7, wherein the received content data from the other communication apparatus is content data generated after a time when the other communication apparatus was associated by the association unit.

9. The communication apparatus according to claim 7, wherein the association unit can associate a plurality of the other communication apparatuses.

10. The communication apparatus according to claim 9, further comprising:
a notification unit configured to, when the operation unit receives the instruction for starting the transmission processing, notifies the user that content data can be received from other communication apparatus associated by the association unit,
wherein, when a plurality of other communication apparatuses is associated by the association unit, the notification unit notifies the user that content data can be received from a communication apparatus from which content data has not yet been received by the receiving unit.

11. The communication apparatus according to claim 7, wherein the receiving unit is configured to receive content data from one communication apparatus at one time.

12. The communication apparatus according to claim 11, wherein, when the transmission unit completes transmitting to the information processing apparatus the content data received from the associated other communication apparatus, the association unit disassociates the associated other communication apparatus.

13. The communication apparatus according to claim 11, wherein, when the receiving unit receives content data from the associated other communication apparatus, the association unit disassociates the associated other communication apparatus.

14. The communication apparatus according to claim 1, further comprising:
a changing unit configured to rename the received content data according to a naming format of the content data already stored by the storage unit.

15. The communication apparatus according to claim 14, wherein the changing unit performs rename processing between when the receiving unit receives renaming target content data and when the transmission unit transmits the renaming target content data to the information processing apparatus.

16. The communication apparatus according to claim 1, further comprising:
an imaging unit,
wherein the storage unit stores as the content data image data generated by the imaging unit.

17. The communication apparatus according to claim 1, wherein the receiving unit receives image data from the other communication apparatus as the content data.

18. A method for controlling a communication apparatus, the method comprising:
storing content data;
transmitting the stored first content data to an information processing apparatus;
accepting a user instruction;
receiving, after acceptance of an instruction for starting transmission processing for transmitting the stored first content data to the information processing apparatus, second content data stored in another communication apparatus; and
considering, when the content data stored in the communication apparatus is received, the content data received by the receiving unit in addition to the first content data as transmission target content data to the information processing apparatus.

19. A non-transitory computer readable recording medium which records a program for causing a computer to execute a method according to claim 18.
